(19) United States
(12) Patent Application Publication
(10) Pub. No.: US 2020/0055342 A1
(43) Pub. Date: Feb. 20, 2020

(54) Pneumatic vehicle tyre with a belt ply having steel monofilaments

(71) Applicant: Continental Reifen Deutschland GmbH, Hannover (DE)

(72) Inventors: Joana Palvras, Hannover (DE); Viktoria Werner, Garbsen (DE); Lubos Novosad, Puchov (SK)

(73) Assignee: Continental Reifen Deutschland GmbH, Hannover (DE)

(21) Appl. No.: 16/344,813

(22) PCT Filed: Sep. 28, 2017
(86) PCT No.: PCT/EP2017/074572

§ 371 Date: Apr. 25, 2019

(30) Foreign Application Priority Data
Nov. 25, 2016 (DE) 10 2016 223 397.1
Dec. 16, 2016 (DE) 10 2016 225 231.3

(51) Int. Cl. B60C 9/00; B60C 9/20

(52) U.S. Cl. CPC B60C 9/0064; B60C 9/0007; B60C 2009/2016; B60C 2009/0085; B60C 9/2006

(57) ABSTRACT

The invention relates to a pneumatic vehicle tire having two or more belt plies which have reinforcement members crossing one another at an angle, wherein the reinforcement members within each belt ply are arranged substantially parallel to and spaced apart from one another and are embedded in rubber material, wherein the belt has at least one first belt ply, the reinforcement members of which are formed by steel monofilaments of the reinforcement member class Ultra-Tensile (UT) with in each case a tensile strength of 3080 N/mm² to 4190 N/mm², wherein the steel monofilaments have a diameter D of 0.33 mm to 0.37 mm. It is the object of the invention to provide, at lower cost, a pneumatic vehicle tyre with low rolling resistance, by way of simultaneously simplified production. This is achieved in that the steel monofilaments have a torsion value of approximately zero windings in the case of a length dimension of 200 times the diameter of the steel monofilament.

The invention relates to a pneumatic vehicle tire having two or more belt plies which have reinforcement members crossing one another at an angle, wherein the reinforcement members within each belt ply are arranged substantially parallel to and spaced apart from one another and are embedded in rubber material, wherein the belt has at least one first belt ply, the reinforcement members of which are formed by steel monofilaments of the reinforcement member class Ultra-Tensile (UT) with in each case a tensile strength of 3080 N/mm² to 4190 N/mm², wherein the steel monofilaments have a diameter D of 0.33 mm to 0.37 mm.

A pneumatic vehicle tire of radial type of construction generally has an inner layer which is impermeable to air, a radial carcass comprising reinforcement members, which carcass extends from the zenith region of the tire via the side walls into the bead region and is normally anchored there by being looped around tension-resistant bead cores, a radially externally situated profiled tread, and a belt arranged between the tread and the carcass, which belt has reinforcement member plies and is commonly covered radially on the outside by the belt bandage. The belt bandage may be of single-ply or multi-ply form and covers at least the belt edges.

It is conventional that, for the production of a belt ply, reinforcement members are embedded in rubber by virtue of a set of reinforcement members that lie substantially parallel running in a longitudinal direction through a calender or an extruder in order to be encased with the rubber mixture. These webs are generally cut transversely with respect to their longitudinal direction, such that the parts, individually or joined together, can be used as strengthening member plies in the tire.

The belt, which is composed of two or more belt plies which cross at an angle, ensures the stiffness of the tread in the longitudinal and transverse directions. During travel, this serves for the power transmission, improves the lateral control, and reduces the wear of the tire.

It is known, and nowadays common, for steel cords to be used as reinforcement members in the belt plies of the belt. The steel cords are arranged substantially parallel to and spaced apart from one another in the reinforcement member ply, and are embedded in rubber material. Belt plies installed in passenger motor vehicle pneumatic tires commonly have steel cords of 2×0.30 mm construction, with a setting of 80 epdm or more. The 2×0.30 mm cord construction means that two wires (monofilaments) of 0.30 mm diameter are twisted together to form a cord, such that the cord has a diameter of approximately 0.60 mm. A disadvantage of belt plies with the above-mentioned steel cords is that they are of relatively heavy weight and involve a large amount of material, which has an adverse effect on the rolling resistance.

Belt plies are also known which, as reinforcement members, have steel monofilaments with a radius of 0.30 mm, wherein the steel is of the reinforcement member class High-Tensile (HT) with a tensile strength of less than 3000 N/mm². In this way, thin reinforcement member plies are created, which has an advantageous effect on the rolling resistance. A disadvantage of such reinforcement member plies is however that the above-mentioned relatively thin monofilaments composed of HT steel may, after being embedded in elastomer material, exhibit internal stresses originating from the coil geometry, whereby the resulting web may exhibit an undulation. In particular at cut edges of the web transverse with respect to the direction of extent of the reinforcement members, an at least partial elevation of the web may occur (“tip rising”). As a result, the processability, in particular the processability during the joining-together of cut web parts to form the strengthening member ply, and the production of the tire, are made more difficult and expensive.

DE 697 08 355 T2 discloses a pneumatic vehicle tire having a belt ply comprising reinforcement members composed of steel monofilaments with a diameter of 0.35 mm composed of steel with a tensile strength of 3423 N/mm², which are arranged with a cord spacing of approximately 129 epdm. Here, the steel monofilaments have a torsion value of 61 windings with a length dimension of 200 times the diameter of the monofilaments.

The torsion of the steel monofilaments reduces the abovedescribed internal stresses and thus facilitates the production of the tire. However, such torsion of the steel monofilaments is associated with an additional process step in the manufacture of the steel monofilaments, and is thus cumbersome and expensive.

It is therefore the object of the invention to provide, at lower cost, a pneumatic vehicle tyre with low rolling resistance, by way of simultaneously simplified production.

The object is achieved in that the torsion value of the steel monofilaments amounts to approximately zero windings. Here, the torsion value of a steel monofilament relates to a length dimension of 200 times the diameter of the steel monofilament.

In the context of the invention, a torsion of approximately zero windings means that the steel monofilament has not undergone any extra process step to realize a torsion. The steel monofilament may however by all means attain a small torsion for example during storage and/or processing, in particular as a result of the steel monofilament being wound onto and/or unwound from coils or drums. This torsion of the steel monofilaments installed in the tire amounts in this case to at most three windings in relation to a length dimension of 200 times the diameter of the respective steel monofilaments.

In the context of the invention, a steel of the reinforcement member class Ultra-Tensile (UT) has a tensile strength of 3080 N/mm² to 4190 N/mm². The “tensile strength” is the tensile stress required to rupture a test subject. It is calculated from the breaking stress determined during the test in relation to the original cross section of the test body. The tensile strength is measured in accordance with ASTM D 2969, ASTM D 4975 and BISTA E6. The force-elongation curve for determining the stress is measured in accordance with ASTM D 2969, ASTM D 4975 and BISTA E6.

Such relatively thin steel monofilaments composed of steel of the reinforcement member class UT (Ultra-Tensile) with a torsion of approximately zero windings are extremely highly suited to use as reinforcement members of a belt ply of a pneumatic vehicle tire. It has been found that webs with steel monofilaments composed of steel of the reinforcement member class UT, even in the case of a small diameter D of 0.33 mm to 0.37 mm, exhibit very little undulation and very little tip rising at cut edges, which no longer have an adverse effect on the processability and the production of the tire. Furthermore, the cumbersome process step of twisting the steel monofilaments to attain torsion is eliminated. In this way, the processability is facilitated, and the production of the tire is simplified. Such a tire can be produced at lower cost. At the same time, by means of the furthermore small diameter of the steel monofilaments, the weight and the use of material for the first belt ply are furthermore kept low, and the tire furthermore has an advantageous rolling resistance.

A pneumatic vehicle tire with low rolling resistance is thus provided, at lower cost, by way of simultaneously simplified production.

With regard to the characteristics of processability and rolling resistance, a diameter D of 0.34 mm to 0.36 mm, preferably a diameter D of 0.35 mm, has proven to be particularly advantageous as a diameter of the steel monofilaments.

In the context of the invention, the diameter D is, in formulae, used without units in mm (millimeters). The units in which the calculated variable is defined are stated after the formula.

In one advantageous embodiment, the steel monofilaments have a tensile strength of 3820−2000*D [N/mm²] to 4850−2000*D [N/mm²], where D denotes the diameter of the steel monofilaments. Steel monofilaments of this tensile strength exhibit particularly advantageous processability. A diameter of D=0.35 mm thus yields a tensile strength of 3120 N/mm² to 4150 N/mm².

It is advantageous if the steel monofilaments have a breaking strength of 330 N to 390 N, preferably a breaking strength of 350 N to 360 N. It is also advantageous if a force of 204 N to 242 N, preferably a force of 210 N to 230 N, has to be expended for an elongation of the steel monofilaments of 1%. The breaking strength and tensile force are measured in accordance with ASTM D 2969, ASTM D 4975 and BISTA E6. Use is particularly preferably made of steel monofilaments with a diameter of D=0.35 mm.

Sufficient strength, in particular with regard to impact loading, with a simultaneously advantageous small layer thickness of the first belt ply are achieved if the first belt ply, under load in the direction of the reinforcement member ply extent, has a layer strength in the region of A*(4400−2000*D)*(D/2)²*7C [N] per dm width, wherein A assumes a value of 90 to 130. A diameter of D=0.35 mm thus yields a layer strength of 32038 N per dm width to 46278 N per dm width.

In an embodiment which is advantageous with regard to the conflict of aims between handling and rolling resistance, the first belt ply, at a predefined elongation of 1% in the direction of the reinforcement member longitudinal extent, has a stress of B* (4400−2000*D)*(D/2)²*n/1.6 [N] per dm width, wherein B assumes a value of 90 to 130. The force-elongation curve for determining the stress is measured in accordance with ASTM D 2969, ASTM D 4975 and BISTA E6. A diameter of D=0.35 mm thus yields a stress of 20024 N per dm width to 28924 N per dm width.

An advantageous embodiment of the tire is realized if the steel monofilaments in the first belt ply are arranged with 90 epdm to 130 epdm, preferably with 95 epdm or 120 epdm. It is particularly advantageous if the diameter of the steel monofilaments amounts to 0.35 mm, and the filament density amounts to 90 epdm to 100 epdm, preferably 95 epdm.

A pneumatic vehicle tire commonly has two, three, four or more belt plies. Each of these plies may be a first belt ply. It may be a radially innermost ply or a radially outermost ply or a middle belt ply.

It is advantageous here if the belt has two first belt plies, wherein the steel monofilaments of one first belt ply are inclined oppositely to the steel monofilaments of the other first belt ply in relation to the tire circumferential direction.

With regard to weight and use of material, it is particularly advantageous if all of the belt plies of the tire are first belt plies. Such a tire exhibits particularly low rolling resistance.

The advantageous tire according to the invention may be a tire for a passenger motor vehicle, a van, a light truck, a utility vehicle or a motorcycle.

Further advantages of the invention will be discussed in more detail in conjunction with the following examples of first belt plies that can be used in pneumatic vehicle tires according to the invention:

In a first example, a tire of tire size 205/55 R16 has a first belt ply with a belt angle of 26° with respect to the circumferential direction and has, as reinforcement members, steel monofilaments with a diameter D=0.35 mm and a filament density of 95 epdm. Here, the steel monofilaments have a torsion value of approximately zero windings in the case of a length dimension of 200 times the diameter of the steel monofilament. The steel monofilaments have a tensile strength of 3430 N/mm² to 4050 N/mm² auf. The layer has a layer strength of 32040 N per dm width to 37100 N per dm width. Furthermore, the first belt ply, at a predefined elongation of 1% in the direction of the reinforcement member longitudinal extent, has a stress of 20025 N per dm width to 22990 N per dm width.

In a further example, a tire of tire size 185/70 R14 has a first belt ply with a belt angle of 28° with respect to the circumferential direction and has, as reinforcement members, steel monofilaments with a diameter D=0.35 mm and a filament density of 120 epdm. Here, the steel monofilaments have a torsion value of approximately zero windings in the case of a length dimension of 200 times the diameter of the steel monofilament. The steel monofilaments have a tensile strength of 3430 N/mm² to 4050 N/mm² auf. The layer has a layer strength of 39600 N per dm width to 46000 N per dm width. Furthermore, the first belt ply, at a predefined elongation of 1% in the direction of the reinforcement member longitudinal extent, has a stress of 24480 N per dm width to 28900 N per dm width.

1-11. (canceled)

12. A pneumatic vehicle tire comprising a belt having two or more belt plies which have reinforcement members crossing one another at an angle, wherein the reinforcement members within each belt ply are arranged substantially parallel to and spaced apart from one another and are embedded in rubber material;
wherein the belt has at least one first belt ply, the reinforcement members of which are formed by steel monofilaments of the reinforcement member class Ultra-Tensile (UT) with in each case a tensile strength of 3080 N/mm² to 4190 N/mm², wherein the steel monofilaments have a diameter D of 0.33 mm to 0.37 mm; and,
wherein the steel monofilaments have a torsion value of approximately zero windings in the case of a length dimension of 200 times the diameter of the steel monofilament.

13. The pneumatic vehicle tire as claimed in claim 12, wherein the diameter D is 0.34 mm to 0.36 mm.

14. The pneumatic vehicle tire as claimed in claim 13, wherein the diameter D is 0.35 mm.

15. The pneumatic vehicle tire as claimed in claim 12, wherein the steel monofilaments have in each case a tensile strength of 3820−2000*D [N/mm²] to 4850−2000*D [N/mm²], where D denotes the diameter of the steel monofilaments.

16. The pneumatic vehicle tire as claimed in claim 12, wherein the steel monofilaments have a diameter of D=0.35 mm, in that they have a breaking strength of 350 N to 360 N, and in that an elongation of 1% is caused by a force of 204 N to 242 N.

17. The pneumatic vehicle tire as claimed in claim 12, wherein the first belt ply, under load in the direction of the reinforcement member ply extent, has a layer strength in the region of A* (4400−2000*D)*(D/2)²*7C [N] per dm width, wherein A assumes a value of 90 to 130.

18. The pneumatic vehicle tire as claimed in claim 12, wherein the first belt ply, at a predefined elongation of 1% in the direction of the reinforcement member longitudinal extent, has a stress of B* (4400−2000*D)*(D/2)²*n/1.6 [N] per dm width, wherein B assumes a value of 90 to 130.

19. The pneumatic vehicle tire as claimed in claim 12, wherein the steel monofilaments in the first belt ply are arranged with 90 epdm to 130 epdm.

20. The pneumatic vehicle tire as claimed in claim 19, wherein the steel monofilaments in the first belt ply are arranged with 95 epdm or 120 epdm.

21. The pneumatic vehicle tire as claimed in claim 12, wherein the diameter of the steel monofilaments amounts to 0.35 mm, and the filament density amounts to 90 epdm to 100 epdm, preferably 95 epdm.

22. The pneumatic vehicle tire as claimed in claim 12, wherein the belt has exactly two belt plies, and in that the two belt plies are first belt plies.

23. The pneumatic vehicle tire as claimed in claim 12, wherein all belt plies of the belt are first belt plies.

24. The pneumatic vehicle tire as claimed in claim 12, wherein it is a tire for a passenger motor vehicle, a van, a light truck, a utility vehicle or a motorcycle.
